(19) United States
(12) Patent Application Publication
(10) Pub. No.: US 2007/0089162 A1
(43) Pub. Date: Apr. 19, 2007

(54) Method of controlling service access in ubiquitous environments and middleware therefor

(75) Inventors: Won Joo Park, Daejeon-city (KR); Dong Il Seo, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/399,083

(22) Filed: Apr. 5, 2006

(30) Foreign Application Priority Data
Oct. 14, 2005 (KR) 10-2005-0096946

(51) Int. Cl. H04L 9/00

(52) U.S. Cl. 726/1

(57) ABSTRACT

A security middleware for controlling service access in ubiquitous environments and a method thereby are provided. The security middleware includes: a service discovery manager discovering services needed for an application; a RBAC UA manager determining services accessible by a role of which a user of the application is assigned to a member, among the discovered services; and a RBAC session manager connecting a session for the services accessible by the role. Therefore, controlling service access may be achieved.

### CROSS-REFERENCE TO RELATED PATENT APPLICATION

This application claims the benefit of Korean Patent Application No. 10-2005-0096946, filed on Oct. 14, 2005, in the Korean Intellectual Property Office, the disclosure of which is incorporated herein in its entirety by reference.

### BACKGROUND OF THE INVENTION

1. Field of the Invention

The present invention relates to a ubiquitous security middleware, and more particularly, to a security middleware for controlling service access for an application by considering flexibility of an application and a service in ubiquitous environments, and a method thereby.

2. Description of the Related Art

In ubiquitous environments, applications are dynamically connected to services and disconnected from the services, and therefore it is important to determine whether the executed application is trustworthy and to determine whether the application has access right for the services.

Conventional ubiquitous middlewares have a structure that the application can adapt to a dynamically variable context, and however it is not examined whether the application has access right to the service, so the service is not safe from threats of the harmful application.

The research on security in ubiquitous environments is important as much as development of the main techniques of the ubiquitous environments. However, conventional ubiquitous security has been researched case by case, and therefore research on proper security platforms in correspondence to time-varying surrounding information on a person, a place, and an object is not suggested. The conventional ubiquitous middlewares may reflect time-varying surrounding information that is context information to some extent, and however, the security is unreliable.

### SUMMARY OF THE INVENTION

The present invention provides a method of controlling service access in ubiquitous environments by using a role-based access control (RBAC) system and a security middleware therefor.

The present invention also provides a computer-readable medium having embodied thereon a computer program for the method of controlling service access in ubiquitous environments.

According to an aspect of the present invention, there is provided a ubiquitous security middleware including: a service discovery manager discovering services needed for execution of an application; a RBAC UA manager determining services accessible by a role of which a user of the application is assigned to a member, among the discovered services; and a RBAC session manager connecting a session for the services accessible by the role.

According to another aspect of the present invention, there is provided a method of controlling service access in a security middleware, including: (a) discovering services needed for execution of an application; (b) determining services accessible by a role of which a user of the application is assigned to a member, among the discovered services; and (c) connecting a session for the services accessible by the role.

Therefore, access right for services and resources may be controlled.

In ubiquitous computing environments, the security focuses on privacy. In the ubiquitous environments, the application uses various resources and services to support user's action without user's handling. Therefore, if access to personal information by the application can not be controlled, serious privacy invasion may occur.

For example, in case of positioning system determining where a user is or where the user goes, if a harmful application intends to use the above-mentioned information, a device for controlling access to the information is needed. This access control is not needed only for harmful attack, but also for preventing other people from acquiring the personal information of the user.

### BRIEF DESCRIPTION OF THE DRAWINGS

The above and other features and advantages of the present invention will become more apparent by describing in detail exemplary embodiments thereof with reference to the attached drawings in which:

FIG. 1 shows an embodiment of a structure of a ubiquitous security middleware according to the present invention;

FIG. 2 shows an example of a method of controlling service access by using a role based access control (RBAC) system in ubiquitous environments according to the present invention;

FIG. 3 is a schematic view showing a method of controlling service access by the use of an RBAC model according to the present invention; and

FIG. 4 is a flow chart showing an embodiment of a method of controlling service access in ubiquitous environments according to the present invention.

### DETAILED DESCRIPTION OF THE INVENTION

Now, a security middleware for controlling service access in ubiquitous environments and a method of controlling service access according to the present invention will be described in detail with reference to the accompanying drawings.

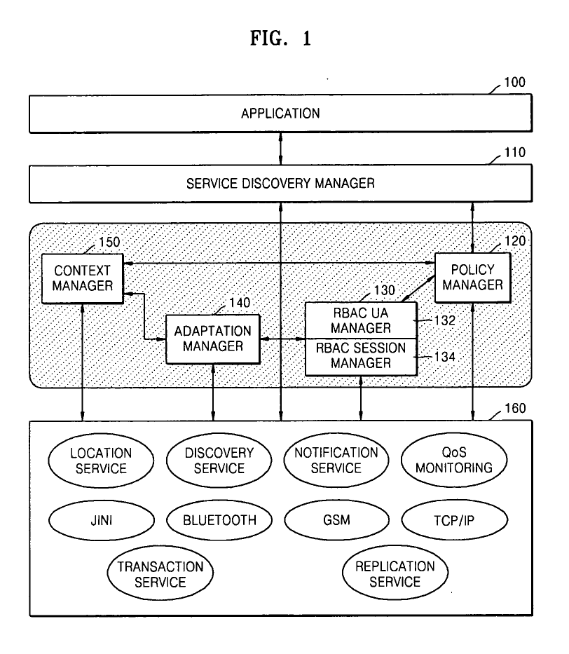

FIG. 1 shows an embodiment of a structure of a ubiquitous security middleware according to the present invention.

Referring to FIG. 1, the security middleware includes an application 100, a service discovery manager 110, a policy manager 120, a role-based access control (RBAC) manager 130, an adaptation manager 140, and a context manager 150.

The application 100 is a task which is performed by a user. If the user executes the application for a task, the application requests resources and services 160 needed for the execution from the service discovery manager 110. However, the application is not to be limited to specific resources and services. In the ubiquitous environments, the application 100 may use various resources and services performing the same function. That is, the application may use new resources and new services which are produced when the application is executed. The resources and services needed for the execution of the application 100 are, therefore, described abstractly, and 100 the resources and services needed for the execution of the application is specified when the application 100 is executed.

When the service discovery manager 110 receives a request for discovering the resources and services from the application 100, the service discovery manager 110 returns the list of resource and service available to execute the application. In ubiquitous environments, the resources and services exist in a region where the application is executed, or the resources and services exist in distributed environment physically.

Accordingly, mechanism for discovering the necessary resources and services is embodied in a service discovery manager 110 to execute the application by providing the resources and services needed for the application in the above environment. The service discovery manager 110 maintains and manages the list to dynamically discover and identify the resource and service required by the application. The service discovery manager 110 receives the service discovery request and returns the available service list to the application 100.

The context manager 150 specifies and discovers a context to determine a meaningful context. The context means all information for specifying the environment of an object executing the application. The object may be a person, place, or a physical or calculable object.

The context manager 150 is used for recognizing the context, and the recognizing the context includes: specifying the context; discovering the context; analyzing the discovered context; and determining the meaningful context. The context determination includes predicting a change which may occur in the future or determining a desirable context among the contexts which are conflicting to each other. The RBAC manager 130 and the adaptation manager 140 perform a recognition access control and a context recognition adaptation with reference to the context manager 150.

The adaptation manager 140 determines reactions against the changes of the application 100 or the user context with reference to the context manager 150, and performs an adaptation rule.

When a request for determining whether the service discovered by the service discovery manager 110 is controlled by the specific policy is received, the policy manager 120 examines the role assignment of the application, consistently adds, deletes, and modifies the policy, so as to assign an adequate adaptation rule. That is, the policy manager 120 consistently applies the policy which is a set of rules having a specific purpose related to a community's purpose.

An example of an adaptation rule is a prohibition rule which states: “The role belonging to the community is prohibited from being executed for a predetermined time.” In addition, duty or authority related to the role may be determined as an adaptation rule.

The policy manager 120 maintains adaptation rules consistently and can grant priorities to the adaptation rules according to the importance accorded with the purpose. The policy manager 120 inquires of a RBAC manager whether the role is assigned to the user of the application or the application, to perform a request from the service discovery manager 110 (that is, a request for determining whether the discovered service is controlled by a specific policy).

The RBAC manager 130 controls access to resources and services, and prevents conflicts of tasks on the basis of a RBAC method. Elements of policy language using the RBAC are a subject, a role, succession, and authority.

The subject is each user who describes a policy with the authority for setting a current policy, and the role is a role of RBAC defined in this structure. The roles are classified into existing roles which are for the existing environments and user-defined roles which are modified in view of new privacy. The authority consists of a couple of an event object and an operation which the role can perform for the event object. The object is the event object given to the role, and the operation is what the object can perform. The succession is performed with reference to the conventional role hierarchy, or an event authority can be succeeded according to a user-defined role hierarchy.

In the RBAC, the authorities for performing the operation for the service are assigned not to a user or the application directly, but to the role defined in the given environments. Accordingly, in order to perform the operation for the service desired by the user or the application, the user or the application has to be a member of the role having the authority for performing the operation for the service.

When the RBAC manager 130 determines whether the user has the access authority to the discovered services, the RBAC manager 130 considers the current context and policy. The RBAC manager 130 consists of an RBAC UA manager 132 and an RBAC session manager 134.

The RBAC UA manager 132 assigns the authority for performing the operations for the services to the role for executing the task, instead of assigning the authority to the user directly. Accordingly, the user can perform the operation for the service by being a member of the corresponding role.

The RBAC UA manager 132 examines whether the user who executes the application for the specific services suggested by the service discovery manager 110, can perform the operation for the specific.

In the ubiquitous security middleware, the relation between the user and the application is a many-to-many relationship, and the relation between the application and the session is a one-to-many relationship. Each session is related to one user like conventional RBAC, and each user can be related to a plurality of sessions. In the RBAC, the session can be defined as a set consisting of one user and a plurality of roles, and the user can perform the whole or part of roles assigned to himself through the session.

Accordingly, the RBAC session manager 134 receives the environment value, which the adaptation manager 140 in ubiquitous environments receives from the context manager 150, as the event value and selects a session adequate for surroundings of the user.

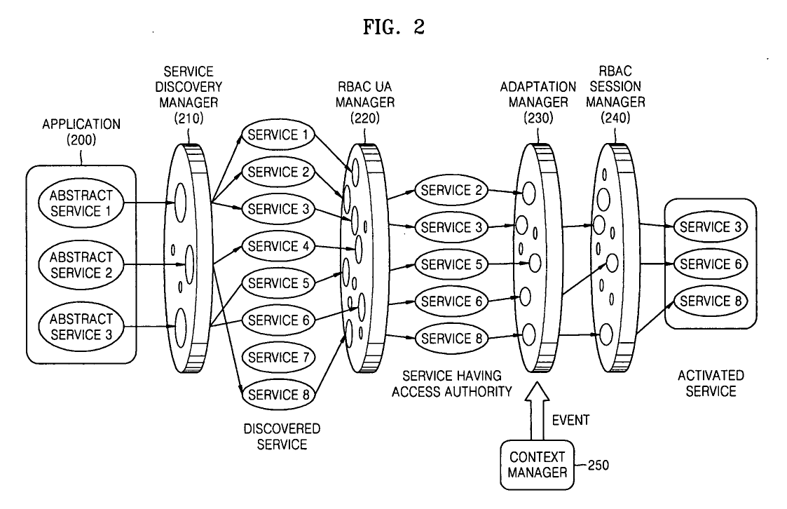

FIG. 2 shows an example of a method of controlling service access by the use of role based access control in ubiquitous environments according to the present invention.

Referring to FIG. 2, the application 200 is not limited to the specific resources and services and described abstractly to adapt to the environment when the application 200 is executed. For example, in the application 200, the service is abstractly described like a location service, while the service is not concretely described like a GPS-based location service or web-based location service. The list of the services which are abstractly described in the application 200 is sent to the service discovery manager 210.

The service discovery manager 210 which receives an abstract service list including a location service, determines whether the GPS-based location service or the web-based location service is locally available, or otherwise the service discovery manager 210 determines whether the GPS-based location service or the web-based location service is remotely available and then determines how many hops the service is available within. That is, the service discovery manager 210 discovers available resources and services for abstractly described services and makes a list of information on the discovered services (information on whether the discovered service is locally available or remotely available, or information on which service is the discovered service).

The service discovery manager 210 inquires of the RBAC UA manager 220 determining whether the user who executes the application 200 has the authority for the services. The access authorities for the services are assigned to roles, and therefore the RBAC UA manager 220 examines whether a user is assigned to the role and determines the access authority.

In case that the access authority for the discovered service exists, the application 200 can use the service. The number of available services may be zero, or two or more. When the number of available services is zero, the adaptation manager refers to the context manager 250 and sends a request for discovering alternative services to the service discovery manager 210. When the service discovery manager 210 discovers the alternative services, the RBAC UA 220 determines whether the access authority exists. If two or more services are available, the adaptation manager 230 determines an optimal service for the current application with reference to the context manager 250.

When the available optimal service is determined in consideration of the user's context, the adaptation manager 230 connects a corresponding session through a RBAC session manager 240, activates the role needed for executing the available service, and adapts the application to the role.

Thereafter, the ubiquitous security middleware watches changes of resources and services and performs the adaptation to the changes of resources and services continuously.

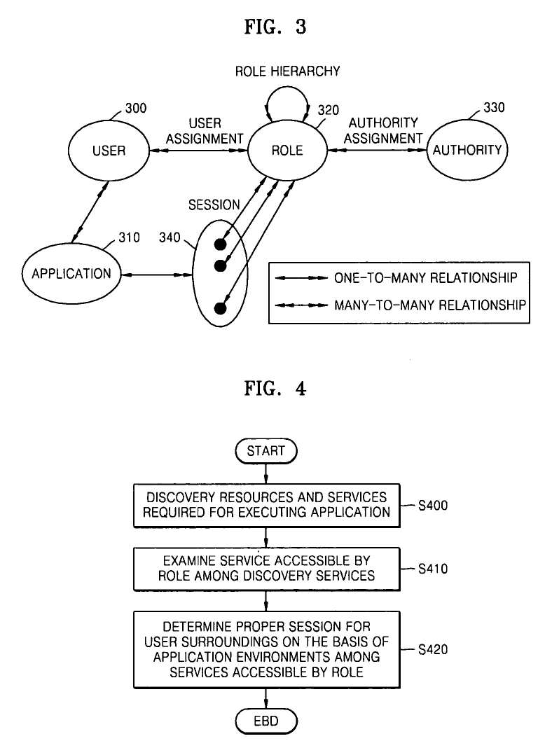

FIG. 3 is a schematic view showing a method of controlling service access by using a role based access control model according to the present invention.

When a user 300 executes an application 300, the security middleware discovers available services for executing the application, at executing time. The RBAC UA manager examines whether the user who executes the application 300 is assigned to the role 320 for executing the operation, with respect to the specific services suggested by the service discovery manager. The adaptation manager refers to the context manager. If the context is changed, the adaptation manager determines proper adaptation and performs an adaptation rule. The adaptation manager opens a proper session 340 for the user through the RBAC session manager without user's handling.

FIG. 4 is a flow chart showing an embodiment of a method of controlling service access in ubiquitous environments according to the present invention.

Referring to FIG. 4, the security middleware discovers the resources and services for executing the application. The security middleware determines whether the user using the application is a member of the role having the access authority for the discovered service and examines the access authority for the service for the application (S410). Then the security middleware selects the proper service for the user surroundings with reference to the context of the application and generates the session for the selected service.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, a person's privacy (where the person is, with whom the person is, or what the person is doing) is protected by controlling the user access authority for the services needed for the application in the ubiquitous environments.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A ubiquitous security middleware comprising:
a service discovery manager discovering services needed for execution of an application;
a RBAC UA manager determining services accessible by a role of which a user of the application is assigned to a member, among the discovered services; and
a RBAC session manager connecting a session for the services accessible by the role.

2. The ubiquitous security middleware of claim 1, further comprising:
a context manager discovering and managing a context defining environments of the user who requires executing the application; and
an adaptation manager selecting an optimal service for executing the application, among the services accessible by the role, on the basis of the context corresponding to the user,
wherein the RBAC session manager connects the session for the services selected by the adaptation manager.

3. The ubiquitous security middleware of claim 1, wherein the service discovery manager receives a request for discovering the service abstractly described in the application.

4. A method of controlling service access in a security middleware, the method comprising:
(a) discovering services needed for execution of an application;
(b) determining services accessible by a role of which a user of the application is assigned to a member, among the discovered services; and
(c) connecting a session for the services accessible by the role.

5. The method of claim 4, wherein (b) comprises discovering and managing a context defining environments of the user who requires executing the application, and
(c) comprises selecting an optimal service for executing the application, among the services accessible by the role, on the basis of the context corresponding to the user.

6. The method of claim 4, wherein (a) comprises discovering services corresponding to a request for discovering the service abstractly described in the application when receiving the request for discovering the service abstractly described in the application.
